(19) United States
(12) Patent Application Publication
(10) Pub. No.: US 2025/0208087 A1
(43) Pub. Date: Jun. 26, 2025

(54) BREAK-RESISTANT GLASS COMPONENT FOR A SENSOR CONTAINING GLASS COMPONENTS ON THE OUTER SHELL

(71) Applicant: Endress+Hauser Conducta GmbH+Co. KG, Gerlingen (DE)

(72) Inventors: Matthäus Speck, Göpfersdorf (DE); Thomas Wilhelm, Chemnitz (DE)

(21) Appl. No.: 18/985,656

(22) Filed: Dec. 18, 2024

(30) Foreign Application Priority Data
Dec. 21, 2023 (DE) 10 2023 136 320.4

(51) Int. Cl. G01N 27/36

(52) U.S. Cl. CPC G01N 27/36

(57) ABSTRACT

A method for producing a break-resistant glass component of an analyte-sensitive sensor includes providing at least one glass component of a sensor, which consists of a sodium-containing and/or lithium-containing glass, such as a sodium silicate and/or lithium silicate glass, and bringing the at least one glass component into contact with a melt or solution containing potassium nitrate. The glass component includes an inner shaft tube and an outer shaft tube surrounding the inner shaft tube and is connected in a material-locking manner to the inner shaft tube.

### CROSS-REFERENCE TO RELATED APPLICATION

The present application is related to and claims the priority benefit of German Patent Application No. 10 2023 136 320.4, filed on Dec. 21, 2023, the entire contents of which are incorporated herein by reference.

### TECHNICAL FIELD

The present disclosure relates to a sensor containing a break-proof glass component of the sensor and the method for producing the break-proof glass component.

### BACKGROUND

The determination of the concentration of an analyte in a measuring medium plays an important role in many industrial applications, for example in chemical or pharmaceutical engineering, in food technology, in biotechnology, but also in non-industrial analytical applications, for example in environmental measurement technology. For determining ion concentrations, sensors that have a sensor element with an analyte-sensitive component are often used in laboratories and in industrial process plants. An analyte-sensitive membrane, for example, can be used as an analyte-sensitive component. For example, the glass membrane of the known pH glass electrode is sensitive to the concentration or activity of H+ or H3O+ ions in a measuring medium.

Electrochemical sensors with a break-proof glass component, such as a glass shaft component, are very popular, since glass has excellent corrosion resistance to acids and alkalis.

In DE 202006017215 U1, measuring probes with glass electrodes for pH and redox measurements are described.

However, the disadvantage of glass electrodes is their susceptibility to cracking and/or breakage. These are types of problems that can occur in a pH combination electrode, which with a certain probability lead to an incorrect measurement or to the failure of the combination electrode. For example, mechanical stresses arise during the production of the glass assembly if an ion-sensitive membrane glass is attached to a glass component containing a glass shaft, in which the glass components to be connected are heated, melted and deformed using gas burners or other heat sources.

### SUMMARY

The object according to the present disclosure is thus to provide a sensor containing a glass component containing a glass shaft or a glass assembly containing an inner shaft and an outer shaft connected to the inner shaft at the end facing the medium and surrounding the inner tube, wherein the glass component consists of a break-resistant glass, which has better properties in terms of break resistance than the conventionally used sodium-containing and/or lithium-containing glass.

The object is achieved by the method for producing a break-resistant glass component of an analyte-sensitive sensor, comprising providing at least one glass component of a sensor, which consists of a sodium-containing and/or lithium-containing glass, such as of sodium silicate and/or lithium silicate glass, bringing the at least one glass component into contact with a melt or solution containing potassium nitrate, wherein the glass component includes an inner shaft tube and an outer shaft tube surrounding the inner shaft tube and connected in a material-locking manner to the inner shaft tube.

The inner shaft tube is connected to the outer tube in a material-locking manner, for example by fusion, at its end facing the medium during operation. Thus, there is a cavity between the inner tube and the outer tube, wherein the cavity is designed to accommodate the reference electrolyte and a lead element of the reference half-cell.

In one embodiment, the inner tube is longer in the direction of the medium and thus protrudes further in the direction of the medium. In an alternative embodiment, the inner tube and the outer tube are of equal length and protrude in the direction of the medium to the same extent.

By exchanging the sodium ions and lithium ions of the glass for potassium ions at a temperature of 200-400° C., lower-period alkali metal ions, such as sodium and/or lithium ions, in layers close to the surface are replaced by potassium ions. As a result, a surface compressive stress, which hinders crack growth and results in high fracture strength, arises.

According to a Vickers hardness test, a break-resistant glass only shows cracks at loads of over 40 Newtons, while conventional glass already shows cracks at a load of 5 Newtons. As a rule, the break-resistant glass is approximately twice to three times as scratch-resistant as conventional glass. As is well known, with the Vickers hardness measurement, an indenter in the form of a diamond pyramid is pressed against a test specimen with a predetermined test force P. The indenter leaves a square impression in the surface of the test specimen, the diagonals d1, d2 of which are measured and averaged, wherein this average value is a measure of the hardness value to be taken from a table. The Vickers hardness test method is defined in the standards ISO 6507 and ASTM E384.

In one embodiment, the glass component additionally contains at least one of the compounds selected from aluminum oxide, boron oxide, barium oxide, strontium oxide and iron oxide.

In one embodiment, bringing into contact with a potassium-nitrate-containing melt comprises immersing at least a portion of the glass component in the potassium-nitrate-containing melt, wherein the temperature of the potassium nitrate melt is 200-400° C.

In one embodiment, the glass component is completely immersed in the glass melt.

In one embodiment, the temperature of the potassium nitrate melt is 250-350° C., or 320° C. to 330° C., or 300° C.

In one embodiment, the glass component is immersed in the potassium nitrate melt for a period of 2 minutes to 3 hours.

In one embodiment, bringing into contact with a potassium-nitrate-containing solution comprises immersing in a potassium-nitrate-containing solution or sprinkling or spraying with the potassium-nitrate-containing solution, wherein the bringing into contact is followed by a drying step at 200-400° C.

Or, this step takes one minute or less than one minute. In some cases, this step takes 10-30 seconds.

In one embodiment, the ion-sensitive sensor is an analyte-sensitive sensor, such as a cation-sensitive or an anion-sensitive sensor.

In one embodiment, the cation-sensitive sensor is a Na+, K+-sensor or a pH-sensitive or hydronium-ion-sensitive sensor.

In a preferred embodiment, the cation-sensitive sensor is a pH-sensitive or hydronium-ion-sensitive sensor.

The present disclosure also relates to a break-resistant glass component that is obtained by the method according to the present disclosure or an embodiment thereof.

The present disclosure also relates to a method for producing a break-resistant glass component of a reference half-cell of an ion-sensitive glass sensor containing an inner shaft tube and an outer shaft tube surrounding the inner shaft tube and connected in a material-locking manner to the inner shaft tube, comprising the method steps according to the present disclosure or an embodiment thereof, followed by the steps of cooling of the glass component to room temperature cleaning of the glass component, wherein the cleaning is automated and carried out with deionized water.

In a preferred embodiment, the inner shaft tube and the outer shaft tube are connected to one another at the end facing the medium in a material-locking manner, such as by fusing.

The present disclosure also relates to a method for producing the break-resistant glass assembly of an ion-sensitive glass sensor, comprising the method for producing a break-resistant glass component according to the present disclosure or an embodiment thereof, followed by the steps of cooling of the glass component comprising an inner shaft tube and an outer shaft tube surrounding the inner shaft tube and connected in a material-locking manner to the inner shaft tube to room temperature, cleaning of the glass component, wherein the cleaning is automated and carried out with deionized water, and closing of the inner shaft tube (2) by connecting in a material-locking manner or in a mechanical manner the glass component with a pH-sensitive membrane glass.

In embodiments with which the inner shaft tube is closed in a material-locking manner with a pH-sensitive glass membrane, a diaphragm is arranged in the outer tube. The diaphragm can be covered with a protective glass in the glass tube and can be exposed after treatment with potassium nitrate melt or the potassium nitrate solution, for example by milling. In an alternative embodiment, the diaphragm can be inserted into the outer tube containing a corresponding recess after treatment with potassium nitrate melt or the potassium nitrate solution.

The present disclosure also relates to a method for producing the break-resistant glass assembly of an ion-sensitive glass sensor, including the method for producing a break-resistant glass component of a reference half-cell according to the present disclosure, followed by the steps of inserting a cylindrical diaphragm into a recess in the inner shaft tube, wherein the diaphragm on the outer surface, has an O-ring for sealing with the inner shaft tube and on the inside, has a cylindrical cavity and inserting a measuring half-cell, containing a shaft tube and a pH-sensitive glass membrane, into the cylindrical cavity.

The present disclosure also relates to a break-resistant electrochemical sensor including a glass assembly, obtainable by the method according to the present disclosure, a measuring half-cell and a reference half-cell, in each case comprising a lead and an electrolyte, and an electronics unit, which is electrically connected to the lead of the measuring half-cell and the lead of the reference half-cell.

All the modular systems and the measuring systems described above can be combined with each other in each case, provided that this is technically possible.

### BRIEF DESCRIPTION OF THE DRAWING

The present disclosure is explained in more detail in the following description with reference to the embodiments shown in the drawing.

In the drawing:

FIG. 1 shows a glass assembly obtainable by the method according to the present disclosure.

### DETAILED DESCRIPTION

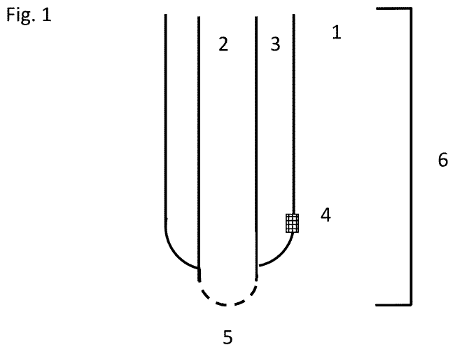

FIG. 1 shows a glass assembly (6) comprising a glass component (1) consisting of an inner shaft tube (2) and an outer shaft tube (3), which consist of break-resistant glass, which are obtained according to the method according to the present disclosure. The outer shaft tube (3) has a diaphragm (4). The inner shaft tube (2) is connected in a material-locking manner to an ion-sensitive membrane glass (5).

1. A method for producing a break-resistant glass component of an analyte-sensitive sensor, comprising
providing at least one glass component of a sensor, which includes a sodium containing and/or lithium-containing glass; and
bringing the glass component into contact with a melt or solution containing potassium nitrate;
wherein the glass component comprises an inner shaft tube and an outer shaft tube surrounding the inner shaft tube and connected in a material-locking manner to the inner shaft tube.

2. The method according to claim 1, wherein the glass component additionally contains at least one of the compounds selected from alumina, boron oxide, barium oxide, strontium oxide and iron oxide.

3. The method according to claim 1, wherein the step of bringing the glass component into contact with the melt or solution containing potassium-nitrate includes immersing at least a portion of the glass component in the melt or solution, wherein the temperature of the melt or solution is 200-400° C.

4. The method according to claim 3, wherein the glass component is completely immersed in the glass melt.

5. The method according to claim 1, wherein the temperature of the melt or solution containing potassium-nitrate is 250-350° C.

6. The method according to claim 1, wherein the glass component is immersed in the melt or solution containing potassium-nitrate for a period of 2 minutes to 3 hours.

7. The method according to claim 1, wherein the step of bringing the glass component into contact with the melt or solution containing potassium-nitrate includes immersing the glass component in a potassium-nitrate-containing solution or sprinkling or spraying the glass component with the potassium-nitrate-containing solution, wherein the bringing step is followed by a drying step at 200-400° C.

8. The method according to claim 1, wherein the ion-sensitive sensor is an analyte-sensitive sensor.

9. The method according to claim 8, wherein a cation-sensitive sensor is a Na⁺, K⁺-sensor or a pH-sensitive or hydronium-ion-sensitive sensor.

10. The method according to claim 9, wherein the cation-sensitive sensor is a pH-sensitive or hydronium-ion-sensitive sensor.

11. A break-resistant glass component for an analyte-sensitive sensor, obtainable by the following method:
providing at least one glass component of a sensor, which includes a sodium containing and/or lithium-containing glass; and
bringing the glass component into contact with a melt or solution containing potassium nitrate;
wherein the glass component comprises an inner shaft tube and an outer shaft tube surrounding the inner shaft tube and connected in a material-locking manner to the inner shaft tube.

12. A method for producing the break-resistant glass assembly of an ion-sensitive glass sensor, comprising:
providing at least one glass component of a sensor, which includes a sodium containing and/or lithium-containing glass;
bringing the glass component into contact with a melt or solution containing potassium nitrate;
wherein the glass component comprises an inner shaft tube and an outer shaft tube surrounding the inner shaft tube and connected in a material-locking manner to the inner shaft tube;
cooling of the glass component to room temperature;
inserting a cylindrical diaphragm into a recess in the inner shaft tube;
wherein the diaphragm on the outer surface, has an O-ring for sealing with the inner shaft tube and on the inside, has a cylindrical cavity; and
inserting a measuring half-cell, containing a shaft tube and a pH-sensitive glass membrane connected in a material-locking manner to the shaft tube, into the cylindrical cavity.
